(19) United States
(12) Patent Application Publication
(10) Pub. No.: US 2018/0075136 A1
(43) Pub. Date: Mar. 15, 2018

(54) METHOD AND ASSOCIATED PROCESSOR FOR ADAPTIVE LINKIFY

(71) Applicant: MEDIATEK Inc., Hsin-Chu (TW)

(72) Inventors: Cheng-Hung Ko, Taipei City (TW); Ting-Hao Chang, New Taipei City (TW)

(21) Appl. No.: 15/262,279

(22) Filed: Sep. 12, 2016

(51) Int. Cl. G06F 17/30

(52) U.S. Cl. CPC G06F 17/30684; G06F 17/30882; G06F 17/30696

(57) ABSTRACT

The invention provides method and associated processor for adaptive linkify of a text. The method may include: by a processor, modifying a current search criterion according to an adaptable factor, searching for match of the modified search criterion in the text, and enabling found match of the modified search criterion to be clickable. The adaptable factor may reflect at least one of the following: a locale setting of the device, a location of the device, manual setting, reachability, linguistic analysis result and system learning result.

### FIELD OF INVENTION

The present invention relates to method and associated processor for adaptive linkify, and more particularly, to method and associated processor enabling adaptive linkify of text by modifying search criterion of linkify according to adaptable factor, e.g., locale and/or location, etc.

### BACKGROUND OF THE INVENTION

Presenting and handling text is essential for modern device, such as mobile phone, tablet computer, notebook computer, portable game console, wearable gadget, etc. Because text may contain identifier strings (e.g., URLs) which identify resources, e.g., documents, files, web pages, email addresses and/or phone numbers, linkify is performed to find if a text contains identifier strings, and then enable found identifier strings, if any, to be clickable.

For example, as shown in FIG. 1, a text 10 may include a string 12 identifying a resource, e.g., a web page. Before linkify, the string 12 is not clickable; i.e., user cannot directly access the resource by clicking the string 12. After performing linkify on the text 10, the string 12 is found to be an identifier string, and then be made clickable, such that user can directly access the resource by simply clicking the string 12.

Conventional linkify uses a fixed search criterion to find identifier strings. For example, RFC 3987 proposed by IETF (internet engineering task force) aims to standardize syntax of identifier string; accordingly, search criterion of conventional linkify is designed to find strings compliant to RFC 3987. However, people of different geometric regions, countries, nations, cultures and languages have a variety of ways to compose text and identify resources, linkify with a same fixed search criterion is insufficient to adapt such variety.

For example, FIG. 2 illustrates a Chinese text 20 which includes a string 22 of two Chinese characters meaning “please go to,” a string 12 identifying a web page, and a string 24 of two Chinese characters meaning “for download.” Since Chinese language has a feature that words of Chinese vocabulary in a sentence are not separated by blank spaces, the strings 22, 12 and 24 in the text 20 are not delimitated by blank spaces, unlike the English text 10 shown in FIG. 1. However, because RFC 3987 allows an identifier string to incorporate characters from universal character set (ISO10646/Unicode), including Chinese characters, linkify based on RFC 3987 will incorrectly recognize the two Chinese characters of the string 24 as a tail portion of an identifier string, along with the string 12. Thus, instead of the true identifier string 12, linkify based on RFC 3987 will erroneously recognize a concatenation of strings 12 and 24 as an identifier string, and make it a clickable hyperlink. However, clicking the hyperlink only leads to a failure (e.g., HTTP 404 error). User experience is therefore degraded.

### SUMMARY OF THE INVENTION

To overcome aforementioned issues, an objective of the invention is providing a method (e.g., FIG. 3 or 4) for adaptive linkify of a text performed by a processor of a device, comprising: by the processor, modifying a current search criterion according to an adaptable factor, and searching for match of the modified search criterion in the text; if a match of the modified search criterion is found, enabling the found match of the modified search criterion to be clickable. The adaptable factor may reflect at least one of the following: a locale (language) setting of the device, a location of the device, a reachability, an analysis result obtained by analyzing linguistic content of the text, and a learning result obtained by performing system learning of past executed linkify; and/or, the method may further include: by the processor, commanding a UI (user interface) of the device to accept manual setting of the adaptable factor. The modified search criterion may be for searching strings identifying at least one of the following: file, web page, email address and phone number. The modified search criterion may be described by regular expression pattern.

Regarding the aforementioned reachability, the method (e.g., FIG. 4) may further include: finding match of the current search criterion in the text; if a match of the current search criterion is found, accessing a portion (e.g., first one or several bytes) of a resource which is identified by the found match of the current search criterion, and generating the reachability to indicate whether the portion of the resource is successfully accessed, wherein accessing the portion of the resource is started automatically rather than manually. The step of modifying the current search criterion according to the adaptable factor may comprise: if the reachability indicates that the portion of the resource is not successfully accessed, enabling the modified search criterion to be different from the current search criterion.

In an embodiment, the step of modifying the current search criterion according to the adaptable factor may comprise: providing different candidate criteria, and selecting one of the candidate criteria as the modified search criterion according to the adaptable factor.

An objective of the invention is providing a processor of a device enabling adaptive linkify of a text. The processor may comprise: an adaptation module for modifying a current search criterion according to an adaptable factor, a search module for searching for match of the modified search criterion in the text, and a formatting module for, if a match of the modified search criterion is found, enabling the found match of the modified search criterion to be clickable. The processor may further include a UI module for commanding a user interface of the device to accept manual setting of the adaptable factor. For reachability, the search module may further find match of the current search criterion in the text, the processor may further include an interface module for, if a match of the current search criterion is found, accessing a portion of a resource which is identified by the found match of the current search criterion. And, the adaptation module may further generate the reachability to indicate whether the portion of the resource is successfully accessed. When the adaptation module modifies the search criterion according to the adaptable factor, the adaptation module may enable the modified search criterion to be different from the current search criterion if the reachability indicates that the portion of the resource is not successfully accessed.

Numerous objects, features and advantages of the present invention will be readily apparent upon a reading of the following detailed description of embodiments of the present invention when taken in conjunction with the accompanying drawings. However, the drawings employed herein are for the purpose of descriptions and should not be regarded as limiting.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1 (prior art) and FIG. 2 (prior art) illustrate examples of conventional linkify;

FIG. 3 illustrates a flowchart according to an embodiment of the invention;

FIG. 4 illustrates a flowchart for reachability according to an embodiment of the invention; and

FIG. 5 illustrates a processor according to an embodiment of the invention.

### DETAILED DESCRIPTION OF PREFERRED EMBODIMENTS

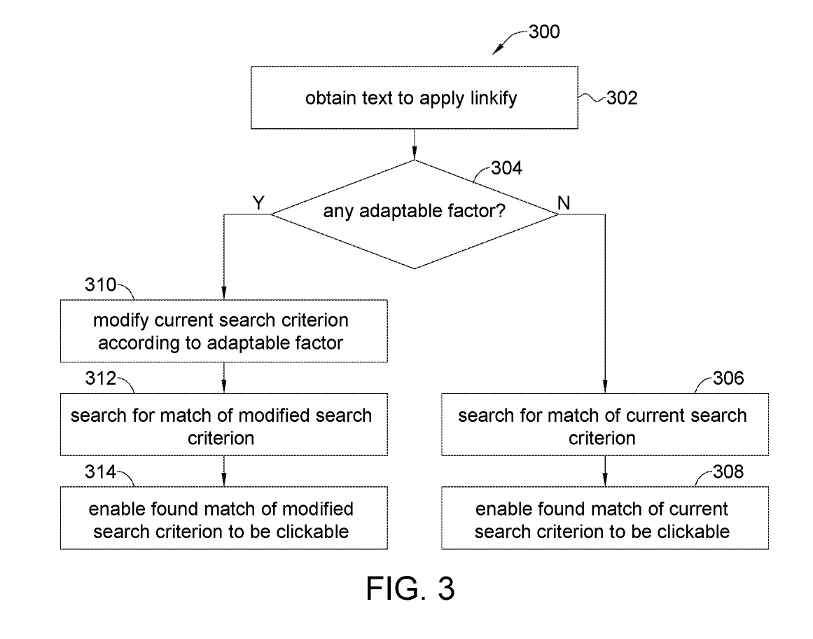

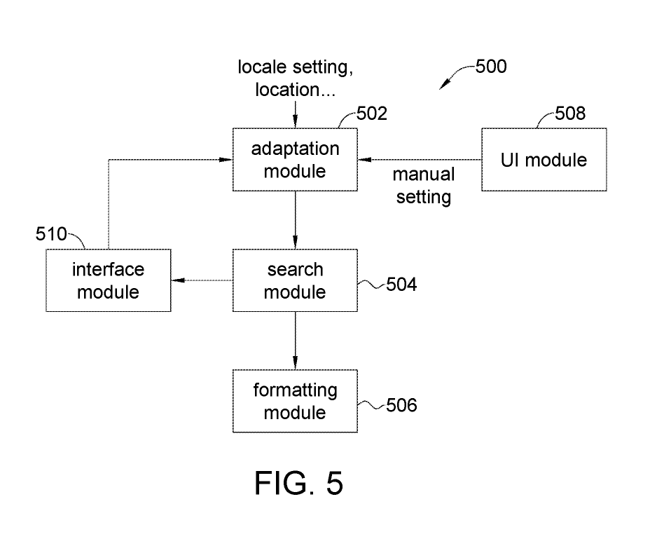

Please refer to FIG. 3 illustrating a flowchart 300 according to an embodiment of the invention. A processor (e.g., 500 in FIG. 5 which will be detailed later) of a device (not shown), e.g., a mobile phone, a tablet computer, a notebook computer, a portable game console or a wearable gadget, may apply the flowchart 300 for adaptive linkify of a text. The flowchart 300 may include the following steps.

Step 302: obtain the text to apply linkify. For example, the text may be content of an email, a message of telecommunication such as an SMS (short message service) message or an MMS (multimedia messaging service) message, an electronic document or file, a web page, or a message of a social communication application software (app).

Step 304: if an adaptable factor is available, proceed to step 310, otherwise proceed to step 306. The flowchart 300 may start with a current search criterion associated with a given adaptable factor; if the adaptable factor is available but equal to the given adaptable factor, the adaptable factor may be considered not available, and the flowchart 300 may proceed to step 306. Details of the adaptable factor will be elaborated later.

Step 306: search for match of the current search criterion in the text. For example, the current search criterion may search identifier strings compliant to RFC 3987. In an embodiment, the operation of searching for match of the current search criterion may include: scanning through the text to look for a first position where a regular expression pattern of the current search criterion produces a match; and returning a corresponding MatchObject instance if zero or more characters at the beginning of the text match the regular expression pattern.

Step 308: if a match of the current search criterion is found at step 306, enable the found match of the current search criterion to be clickable.

Step 310: by the processor of the device, modifying the current search criterion according to the adaptable factor. The modified search criterion may be described by regular expression pattern.

Step 312: search for match of the modified search criterion in the text.

Step 314: if a match of the modified search criterion is found at step 312, enable the found match of the modified search criterion to be clickable. In an embodiment, the modified search criterion may be utilized as the current search criterion for starting next execution of the flowchart 300. In an embodiment, a predetermined common search criterion instead of the modified search criterion may be utilized as the current search criterion for starting next execution of the flowchart 300.

The adaptable factor may reflect locale (language) setting and/or location of the device. For example, if the adaptable factor reflects Chinese related locale setting and/or location (e.g., in China) at step 304, the flowchart 300 may branch to step 310 for modifying the current search criterion to a Chinese adapted criterion which is capable of preventing unexpected mixing of true identifier strings and other unrelated Chinese characters, such as the incorrect concatenation shown in FIG. 2. Similarly, if the adaptable factor reflects Japanese related locale and/or location at step 304, the flowchart 300 may branch to step 310 for modifying the current search criterion to a Japanese adapted criterion capable of preventing unexpected mixing of true identifier strings and unrelated Japanese characters.

In other words, step 310 may include: providing different candidate criteria (e.g., a Chinese adapted criterion, a Japanese adapted criterion and a common criterion) respectively associated with different scenarios (e.g., a Chinese involved scenario, a Japanese involved scenario and a common scenario), and selecting one of the candidate criteria as the modified search criterion according to the adaptable factor. The selection operation may include: comparing the adaptable factor with the scenarios, and then selecting one of the candidate criteria which is associated with the comparable one of the scenarios to be the modified search criterion utilized at step 312 (e.g., selecting the Chinese adapted criterion to be utilized at step 312 if the adaptable factor reflects Chinese involved scenario).

Location of the device may be obtained from device setting, from the network that the device connected with, by leveraging positioning system (e.g., satellite positioning system and/or network positioning system), etc. Besides locale setting and location, the adaptable factor may reflect an analysis result obtained by analyzing linguist content of the text. For example, if most characters of the text are Chinese characters, the adaptable factor may reflect a Chinese involved scenario for a Chinese adapted criterion to be utilized at step 312; on the other hand, if most characters of the text are English characters, the common search criterion may be utilized.

The device may also provide a user interface (not shown) to accept manual setting of the adaptable factor. That is, in an embodiment, the adaptable factor may be manually assigned by user. For example, a U.S. user bilingual in Chinese and English may use a device located in U.S. with English locale setting, but may need Chinese adapted criterion for linkify of Chinese related text. Thus, the user may manually set the adaptable factor to Chinese involved scenario. For example, the processor may command a user interface of the device to accept manual setting of the adaptable factor.

The steps shown in FIG. 3 are for illustration only. According to different embodiments, the steps can be performed in orders different from the order shown in FIG. 3, and one or more steps can be added to or removed from the steps shown in FIG. 3.

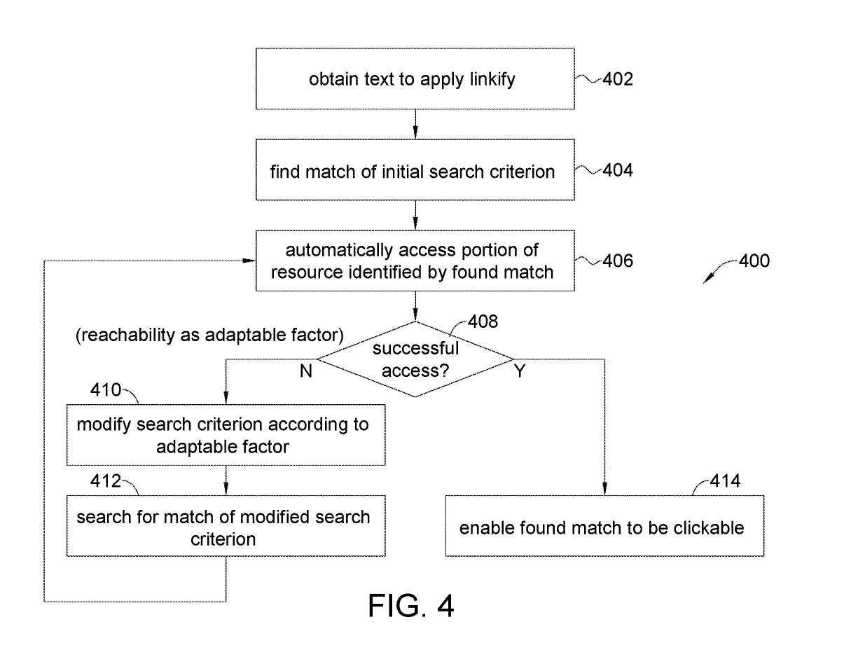

In an embodiment, the adaptable factor may reflect a reachability. Please refer to FIG. 4 illustrating a flowchart 400 for adaptive linkify of a text based on reachability. The flowchart 400 may include the following steps.

Step 402: obtain the text to apply linkify.

Step 404: with an initial search criterion as a current search criterion, find match of the current search criterion in the text.

Step 406: if a match of the current search criterion is found, access a portion (e.g., first one or several bytes) of a resource which is identified by the found match of the current search criterion, and accordingly generate the reachability to indicate whether the portion of the resource is successfully accessed. In other words, step 406 aims to verify if the found match of the current search criterion is an actual identifier of really existed resource.

Step 408: if the reachability indicates that the portion of the resource is not successfully accessed, proceed to step 410, otherwise proceed to step 414. That is, unsuccessful access may lead to an available adaptable factor which directs the flowchart 400 to step 410 instead of step 414.

Step 410: modify the current search criterion according to the adaptable factor which reflects unsuccessful access, such that the modified search criterion is different from the current search criterion. Unsuccessful access means that the found match of the current search criterion is not a correct identifier string, hence linkify may turn to utilize the modified search criterion instead. The modified search criterion may be described by regular expression pattern.

Step 412: in the text, search for match of the modified search criterion of step 410, and iterate back to step 406 with the current search criterion updated to the modified search criterion.

Step 414: enable the found match to be clickable. If the successful access of step 406 is accomplished by using the initial search criterion (step 404), the enabled match is the one found by the initial search criterion. If the successful access of step 406 is accomplished by the search criterion modified at step 410, the enabled match is the one found by the modified search criterion.

It is noted that step 406 (accessing the portion of the resource identified by the match of the current search criterion) may be started automatically by device, rather than manually by user. That is, step 406 may be executed without user intervention, and therefore be silent and transparent with respect to user.

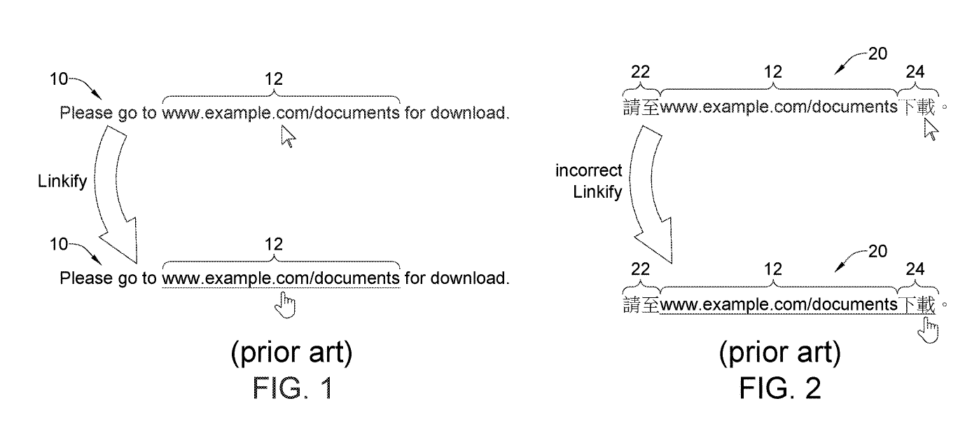

For example, assuming that the text to apply linkify at step 402 is the text 10 shown in FIG. 1, the string 12 will be found as a match of an initial search criterion which is compliant to RFC 3987 (step 404), and the device may automatically access a portion of the resource identified by the string 12 (step 406) for verification before really making the string 12 clickable. In the example of FIG. 1, the string 12 does identifies a valid resource to be successfully accessed, thus the device may then make the string 12 clickable (step 414). On the other hand, assuming that the text to apply linkify at step 402 is the text 20 shown in FIG. 2, a concatenation of the strings 12 and 24 will be found as a match of the initial search criterion (step 404), and the device may automatically access a portion of the resource identified by the concatenation (step 406) before really making the concatenation clickable. Since the concatenation is actually not a correct identifier, accessing resource identified by the concatenation will be unsuccessful, and the failed accessing may cause the modified search criterion to be utilized for a second search of identifier (step 412).

Besides locale setting, location, manual setting, linguistic analysis result and/or reachability, the adaptable factor may also reflect a learning result obtained by performing system learning of past executed linkify. For example, the device may provide a UI for user to report incorrectly recognized identifiers of failed linkify and corresponding correct identifiers; by comparing incorrect and correct identifiers, the device may be trained to correctly modify and compile a regular expression pattern of the current search criterion with an attempts to match the given correct identifiers. That is, accumulated knowledge of incorrect and correct identifiers may be leveraged by the adaptable factor to instruct a correctly modified search criterion.

According to another embodiment, after step 412 is performed, the method may proceed to step 414 instead of step 406. Besides, the steps shown in FIG. 4 are for illustration only. According to different embodiments, the steps can be performed in orders different from the order shown in FIG. 4, and one or more steps can be added to or removed from the steps shown in FIG. 4.

Please refer to FIG. 5 illustrating a processor 500 which may implement the flowchart 300 and/or the flowchart 400. The processor 500 may be an integrated circuit arranged in a device (not shown) to control operation of the device. The processor 500 may enable linkify of a text, and may include an adaptation module 502, a search module 504 and a formatting module 506, along with a UI module 508 and an interface module 510. The adaptation module 502 may modify a search criterion according to an adaptable factor (step 310 and/or 410), the search module 504 may search for match of the modified search criterion in the text (step 312 and/or 412); if a match of the modified search criterion is found, the formatting module 506 may enable the found match of the modified search criterion to be clickable (step 314 and/or 414). The UI module 506 may command a user interface (e.g., touch panel, touch screen, microphone and voice recognizer, gesture sensor, etc., not shown) of the device to accept manual setting of the adaptable factor. On the other hand, the search module 504 may also find match of a current search criterion in the text (step 306), and the formatting module 506 may also enable found match of the current search criterion to be clickable (step 308).

While the adaptable factor may reflect a reachability as described by the flowchart 400 in FIG. 4, the search module 504 may first find match of an initial search criterion in the text (step 404); if a match of the initial search criterion is found, the interface module 510 may automatically and silently start accessing a portion of a resource which is identified by the found match of the initial search criterion (step 406), such that the adaptation module 502 may further generate the reachability to indicate whether the portion of the resource is successfully accessed. If the reachability indicates that the portion of the resource is not successfully accessed (step 408), the adaptation module 502 may modify the search criterion by enabling the modified search criterion to be different from the initial search criterion (step 410).

For modifying search criterion according to the adaptable factor (step 310 and/or 410), the adaptation module 502 may provide different candidate criteria respectively associated with different scenarios, and select one of the candidate criteria according to the adaptable factor, e.g., by comparing the adaptable factor with the scenarios to find a comparable one of the scenarios, and selecting the one which is associated with the comparable one of the scenarios to be the modified search criterion. The modified search criterion may be designed to search strings identifying at least one of the following: file, web page, email address and phone number.

The adaptation module 502, the search module 504 and the formatting module 506 may be implemented by logic circuit which executes firmware and/or software. Circuitry controlling peripherals of manual input/output (e.g., screen, touch panel, keyboard and/or mouse) may contribute to implementation of the UI module 508. Circuitry controlling access of remote (e.g., network) resource may contribute to implementation of the interface module 510.

To sum up, comparing to linkify utilizing a fixed identifier search criterion, linkify proposed by the invention may modify identifier search criterion according to adaptable factor, which may reflect locale setting, location, user preference, reachability, linguistic analysis result and/or system learning result. Therefore, even though people of different geometric regions, countries, nations, cultures and languages have a variety of ways to compose text and describe resource identifiers, the proposed linkify may advantageously adapt the variety, and beneficially enhance experience of ail people.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A method for adaptive linkify of a text performed by a processor of a device, comprising:
by the processor, modifying a current search criterion according to an adaptable factor,
searching for match of the modified search criterion in the text, and
if a match of the modified search criterion is found, enabling the found match of the modified search criterion to be clickable.

2. The method of claim 1, wherein the adaptable factor reflects a locale setting of the device.

3. The method of claim 1, wherein the adaptable factor reflects a location of the device.

4. The method of claim 1 further comprising:
by the processor, commanding a user interface of the device to accept manual setting of the adaptable factor.

5. The method of claim 1, wherein the adaptable factor reflects a reachability, and the method further comprises:
finding match of the current search criterion in the text,
if a match of the current search criterion is found, accessing a portion of a resource which is identified by the found match of the current search criterion, and
generating the reachability to indicate whether the portion of the resource is successfully accessed,
wherein accessing the portion of the resource is started automatically rather than manually.

6. The method of claim 5, wherein the step of modifying the current search criterion according to the adaptable factor comprises:
if the reachability indicates that the portion of the resource is not successfully accessed, enabling the modified search criterion to be different from the current search criterion.

7. The method of claim 1, wherein the adaptable factor reflects an analysis result obtained by analyzing linguistic content of the text.

8. The method of claim 1, wherein the adaptable factor reflects a learning result obtained by performing system learning of past executed linkify.

9. The method of claim 1, wherein the step of modifying the current search criterion according to the adaptable factor comprises:
providing different candidate criteria, and
selecting one of the candidate criteria as the modified search criterion according to the adaptable factor.

10. The method of claim 1, wherein the modified search criterion is for searching strings identifying at least one of the following: file, web page, email address and phone number.

11. A processor of a device enabling adaptive linkify of a text, comprising
an adaptation module for modifying a current search criterion according to an adaptable factor,
a search module for searching for match of the modified search criterion in the text, and
a formatting module for, if a match of the modified search criterion is found, enabling the found match of the modified search criterion to be clickable.

12. The processor of claim 11, wherein the adaptable factor reflects a locale setting of the device.

13. The processor of claim 11, wherein the adaptable factor reflects a location of the device.

14. The processor of claim 11 further comprising:
a UI module for commanding a user interface of the device to accept manual setting of the adaptable factor.

15. The processor of claim 11, wherein:
the adaptable factor reflects a reachability,
the search module further finds match of the current search criterion in the text,
the processor further comprises an interface module for, if a match of the current search criterion is found, accessing a portion of a resource which is identified by the found match of the current search criterion, and
the adaptation module further generates the reachability to indicate whether the portion of the resource is successfully accessed;
wherein accessing the portion of the resource is started automatically rather than manually.

16. The processor of claim 15, wherein the adaptation module modifies the search criterion according to the adaptable factor by:
if the reachability indicates that the portion of the resource is not successfully accessed, enabling the modified search criterion to be different from the current search criterion.

17. The processor of claim 11, wherein the adaptable actor reflects an analysis result obtained by analyzing linguistic content of the text.

18. The processor of claim 11, wherein the adaptable factor reflects a learning result obtained by performing system learning of past executed linkify.

19. The method of claim 11, wherein the adaptation module modifies the search criterion according to the adaptable factor by:
providing different candidate criteria, and
selecting one of the candidate criteria as the modified search criterion according to the adaptable factor.

20. The processor of claim 11, wherein the modified search criterion is for searching strings identifying at least one of the following: web page, email address and phone number.
